(19) United States
(12) Patent Application Publication
(10) Pub. No.: US 2009/0255560 A1
(43) Pub. Date: Oct. 15, 2009

(54) NOZZLE SYSTEM

(76) Inventors: Dennis LEHMANN, Ortenberg (DE); Bruno Gaus, Offenburg (DE); Joachim Kupetz, Berghaupten (DE); Thomas Naeger, Offenburg (DE); Thomas Peukert, Offenburg (DE)

Correspondence Address: Muncy, Geissler, Olds & Lowe, PLLC, P.O. BOX 1364, FAIRFAX, VA, 22038-1364, US

(21) Appl. No.: 12/424,203

(22) Filed: Apr. 15, 2009

(30) Foreign Application Priority Data
Apr. 15, 2008 (DE) 10 2008 018 803.4

(51) Int. Cl. B08B 3/02

(52) U.S. Cl. 134/198

(57) ABSTRACT

A cleaning machine, preferably a dishwasher is provided. The machine comprises at least one spray pipe, spray arm or spray arm blade being substantially of elongate extent which is provided with a plurality of, at least two, nozzles along its elongate extent. Cleaning fluid is sprayed onto items to be cleaned, for example containers or dishes, via the at least two nozzles. The flow of the medium which is to be sprayed on is deflected within the spray pipe directly in front of at least one of the nozzles such that the jet flowing through the nozzle opening contains no flow components which are directed in the longitudinal direction of the spray pipe. As a result, the jet emerges from the spray pipe substantially orthogonally to the axis of symmetry of said spray pipe.

This nonprovisional application claims priority under 35 U.S.C. § 119(a) to German Patent Application No. DE 10 2008 018 803.4, which was filed in Germany on Apr. 15, 2008, and which is herein incorporated by reference.

### BACKGROUND OF THE INVENTION

1. Field of the Invention

The present invention relates to nozzles for dishwashers. In dishwashers, be they domestic dishwashers or dishwashers used in the commercial sector, nozzles are used to distribute the cleaning liquid. A plurality of these nozzles are generally arranged on a spray pipe which has an elongate appearance in the axial direction.

2. Description of the Background Art

In dishwashers, both in the domestic sector and in the commercial sector, nozzles are usually used to spray the cleaning fluid onto the items to be cleaned, for example dishes, glasses, cutlery or the like. The nozzles are generally arranged in a large number on the upper face or lower face of a spray pipe or spray arm which is generally of elongate design. In the spray pipes or spray arms, the dishwashing liquid generally flows in on one side and flows to the nozzles which are arranged one behind the other in the longitudinal direction of the spray pipe.

Spray arms are frequently designed such that they have a bearing point in the center, this bearing point allowing the arm to rotate, with two or more subsections, also called blades, extending away from the bearing point symmetrically, the individual nozzle openings being formed in said subsections. In these design variants of spray arms, the nozzles are supplied with cleaning liquid centrally from the bearing point of the spray arm or of the spray pipe. However, other refinements and types of bearing arrangement are also feasible.

The spray systems have the task or function of allowing the cleaning liquid to emerge in predetermined spray patterns, that is to say as fan jets in similarly predetermined directions, for example orthogonally to the longitudinal axis of the spray pipe or of the spray arm blade or of the spray arm. The required delivered jet form and jet direction are generally determined in experiments during development of the dishwashers and then fixed. The jet pattern should remain unchanged, even if the pressure or the volumetric flow, and the resulting flow rate at which the cleaning liquid is supplied to the nozzle systems, change. The variation may be required for reasons of operation of the dishwasher and amount to ±20% of the rated value.

In commercially used dishwashers, the same type of machine is often constructed with a variety of geometric extents. Therefore, the length of the spray pipes, which are generally arranged in the transverse direction of the machine, that is to say perpendicular to the direction of advance of the items to be cleaned in the case of pass-through dishwashers, may also be changed. If the length of such a spray system changes, a different number of nozzles will be introduced into the spray pipe. Furthermore, a different number of nozzles may also be required from machine to machine due to requirements made by the washware on spray pipes of identical length.

The spray pipes with nozzles are usually produced or designed such that a plurality of round or slot-like openings are made in a tubular body such that they are distributed over the entire length. A further design which is known from the prior art involves initially stamping a continuous groove toward the inside along the pipe and positioning the nozzle openings in this groove. A further design variant known from the prior art involves a cap initially being stamped toward the inside or outside at the points in the spray pipe at which a nozzle is required, and the nozzle opening being positioned in this cap.

The design of this cap and the positioning of the nozzle opening in the cap determine the form of the jet and its direction. For production reasons, it is particularly advantageous when each nozzle can be produced in the same manner, that is to say with respect to form and direction. If a spray pipe of the described type is operated with identical nozzles, it will be observed that the jets at the nozzles are formed in different directions over the longitudinal direction of the pipe, that is to say the jets close to the feed point of the cleaning liquid are inclined to a great extent in the inflow direction of the pipe, whereas the jets emerging from the pipe further away are increasingly less inclined, up until the last jet which is formed approximately orthogonally to the pipe.

This phenomenon, which has a negative influence on the spray pattern or the fan jets, can be prevented by each nozzle being introduced into the spray pipe in its own optimum direction, and therefore the influences from the inner flow in the pipe are counteracted.

If the number of nozzles now changes, given a predefined basic type of spray pipe and its liquid supply, it will be observed that the previously found setting, which relates to the nozzle direction, is no longer complied with. This means that a dedicated optimum arrangement and introduction direction for the nozzle openings has to be determined for each spray pipe variant in a complicated manner and has to be realized during production. However, this results in a considerable additional outlay for experiments and on production of the spray pipes, this being highly disadvantageous. Furthermore, it will be observed that as the supply pressure of the cleaning liquid in the spray pipe varies, the inclination of the jets emerging from the nozzles likewise changes, so that an introduction direction of the nozzle opening which is found to be optimum provides good results only for one operating point.

Instead of the nozzles being punched directly into the casing of the spray pipe and forming these nozzles through the thin wall of the spray pipe or the spray arm or its blades, complete nozzles with a relatively long dedicated inflow section in each case can be inserted into the spray pipe. This approach means a considerably larger number of components and thus makes the system considerably more expensive.

A further way of avoiding the above-described disadvantages involves designing the spray pipes, the spray arms or the spray arm blades with relatively very large cross sections, so that the flow rate of the cleaning liquid within the flow cross section is very low in the interior of the spray pipes or spray arms or spray arm blades. Whereas current spray pipes generally have a circular cross section with a diameter of 43 mm, optimized spray pipes would accordingly have to have a diameter of approximately 100 mm. However, this approach to a solution is likewise disadvantageous on account of the large installation space required for this and the considerable extra outlay on material.

### SUMMARY OF THE INVENTION

It is therefore an object of the present invention to provide a solution with which all the nozzles of a spray pipe can be introduced into the spray pipe, the spray arm or wash arm blade in the same manner and direction and, in spite of this, the jet pattern forms uniformly and consistently, in particular irrespective of the number of nozzles and the supply pressure of the cleaning liquid prevailing in the spray pipe or spray arm.

An embodiment of the invention proposes a spray pipe for subjecting items to be cleaned to the action of cleaning liquid, which spray pipe is designed, in particular, for use in dishwashers. The spray pipe has a longitudinal extent and has, in the longitudinal extent, at least two nozzles for spraying cleaning liquid onto items to be cleaned. The flow of the cleaning liquid is deflected within the spray pipe in front of at least one nozzle in such a way that a jet emerging through a nozzle opening in the nozzle contains substantially no flow components which are directed in the longitudinal direction of the spray pipe and emerges from the at least one nozzle substantially orthogonally to the spray pipe.

A flow profile which is decoupled from a main flow which is formed with a relatively high flow rate in the longitudinal direction of the spray pipe is preferably generated in the spray pipe or spray arm or spray arm blade in front of the outlet nozzles through which the cleaning liquid enters the cleaning chamber or the treatment zone, or in the inflow region of the nozzles. This can be achieved, for example, by means of deflection bodies downstream of which a relatively calmed flow region is established. By means of this measure, the cleaning fluid emerges from the openings in the relevant nozzles substantially without a flow component which is directed in the longitudinal direction of the spray pipe or of the spray arm or of the spray arm blade. The plane of the sprayed jet can therefore be formed substantially orthogonally to the longitudinal axis of the spray pipe or spray arm or spray arm blade. In this case, “substantially” is understood to mean, for example, deviations of not more than 20°, preferably of not more than 10°, and particularly preferably of not more than 5°. A plurality of technical options, which will be described below in conjunction with the drawings, are available for creating this calmed region.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of the negative effects which are established with the conventional solutions;

FIG. 2 shows a first embodiment of the solution proposed according to the invention with a stamped deflection body;

FIG. 3 shows a further, second embodiment of the invention with an incorporated deflection body;

FIG. 4 shows a further, third exemplary embodiment of the solution proposed according to the invention with deflection bodies of tongue-like design; and

FIG. 5 shows a further, fourth embodiment of the solution proposed according to the invention with an incorporated partition plate for dividing the flow channel.

### DETAILED DESCRIPTION

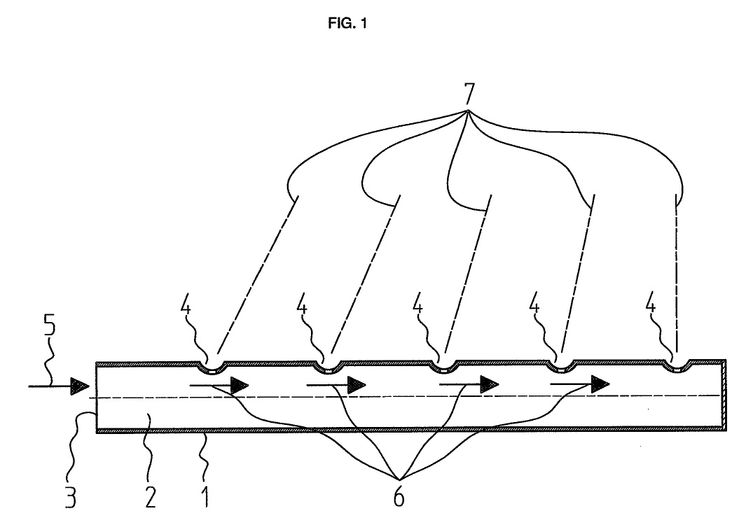

The illustration according to FIG. 1 shows a solution known from the prior art and the negative effects which are established with this solution.

FIG. 1 shows that the flow 6 in the entire spray pipe cross section 2 from the inflow opening 3 to a last nozzle is formed mainly in the longitudinal direction of the spray pipe 1. The relatively small volumetric flows, the individual nozzles 4, which are formed as stampings with a nozzle opening and emerge from these, therefore contain large fractions of movement components in the inflow direction 5 of the spray pipe 1. Consequently, the planes of the nozzle jets 7 emerging from the stampings with nozzle openings 4 are likewise inclined in this direction and are not formed orthogonally to the spray pipe 1 automatically.

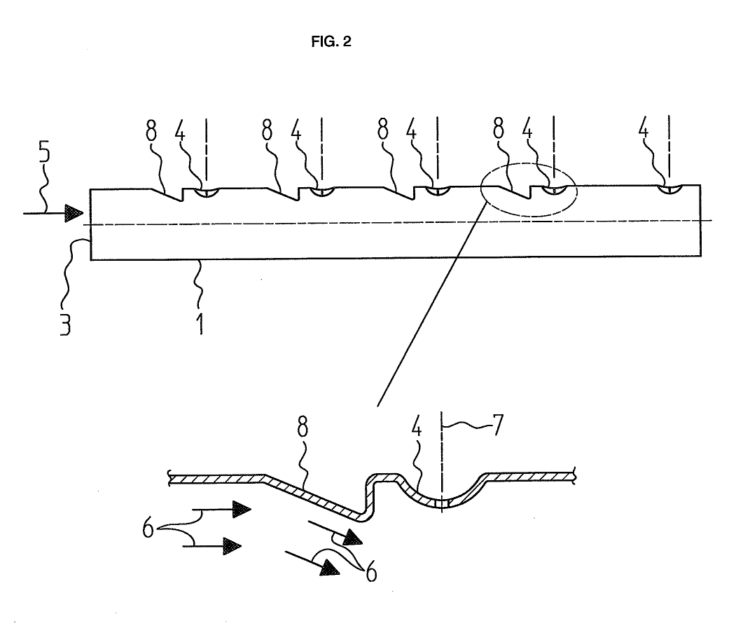

The illustration according to FIG. 2 shows a first design of the solution proposed according to the invention.

The illustration according to FIG. 2 shows a spray pipe 1 which has caps 4 which are stamped toward the inside and in which nozzle openings 4 are directly made, for example by punching. In this case, lug-like deflection bodies 8 are stamped into the casing of the spray pipe 1 in each case in the inflow direction 5 in front of the nozzle openings 4. These deflection bodies 8 deflect the longitudinal flow 6 from the inlet openings into the nozzle in the direction of the axis of symmetry of the spray pipe 1 and generate the desired effect of inflow into the nozzle opening 4, which is stamped in the casing of the spray pipe 1, without being influenced by the longitudinal flow 6. The deflection bodies 8 are preferably introduced into the spray pipe 1 directly at the nozzle opening 4 or the stamping for the nozzle 4, but at most at a distance which corresponds to twice the height of the deflection body 8. The height of the deflection body is preferably selected such that it corresponds to the height of the stamping for the nozzle opening but, at most, is of such a height that the supply to downstream nozzle openings 4, which are stamped in the casing of the spray pipe 1, is not restricted.

This means, for example for a spray pipe 1 which has an inside diameter of approximately 43 mm and in whose casing surface 10 nozzle openings 4 are introduced, that the height of the deflection bodies 8 is of the order of magnitude of 10 mm. If a nozzle or a nozzle opening 4 which is not stamped toward the inside is provided in the casing of the spray pipe 1, the height of the deflection body 8 is to be selected such that it corresponds to the smallest cross section of the nozzle opening. The deflection bodies 8 can be generated, for example, by stampings in the casing of the spray pipe 1 from the outside toward the inside in the immediate vicinity of the nozzle opening 4 in the casing of the spray pipe 1. This is associated with the additional advantage that the production of the deflection bodies 8 and the nozzle openings 4 themselves can be performed in one operation, this being highly economical. Furthermore, no additional components are required which generate extra costs and/or can cause problems during operation.

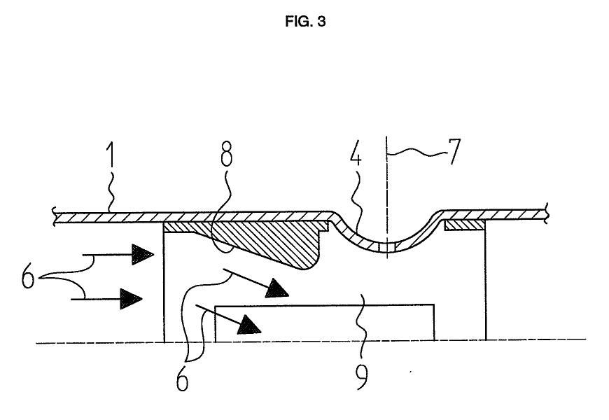

The illustration according to FIG. 3 is a further design variant of the solution proposed according to the invention.

The illustration according to FIG. 3 shows that the deflection bodies 8 are designed as plastic injection-molded parts. These deflection bodies 8, which are formed as plastic injection-molded parts, can be fixed, for example, by means of elastic or rigid retaining elements 9 in the spray pipe cross section 2 of the spray pipe 1. The illustration according to FIG. 3 shows that the retaining body 9 has an opening in the region of the nozzle opening 4, the wall of the spray pipe 1, which wall is stamped toward the inside in the manner of a cap, projecting into the said opening and therefore fixing the retaining element 9 in the axial direction of the spray pipe cross section 2 of the spray pipe 1.

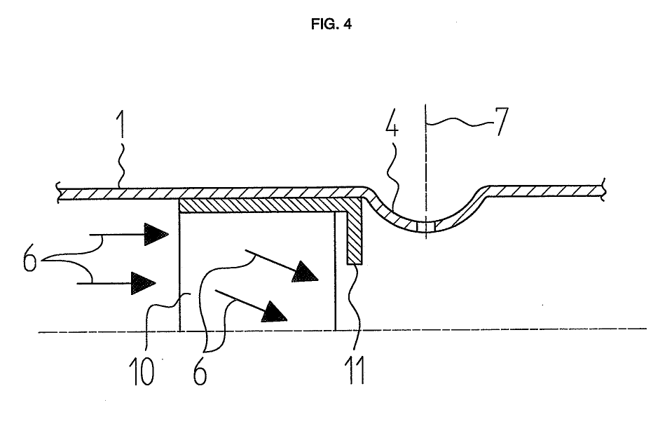

The illustration according to FIG. 4 shows a further embodiment of the solution proposed according to the invention.

In the embodiment illustrated in FIG. 4, the longitudinal flow 6 flowing through the spray pipe cross section 2 is deflected by means of tongues 11. These tongues 11 are embedded in the spray pipe 1 and constrict the spray pipe cross section 2. The sheet-metal part 10 illustrated in FIG. 4 comprises the deflection tongue 11, which can be formed as an end face, at its outflow end, as seen in the direction of flow of the longitudinal flow 6. The sheet-metal part 10 is preferably rotationally symmetrical and its outside diameter preferably matches the inside diameter of the spray pipe 1. A relatively calmed flow region is established downstream of the deflection tongues 11 which run radially inward, a nozzle jet which is orthogonal to the longitudinal axis of the spray pipe 1 being established from the calmed flow region in the region of the nozzle opening 4.

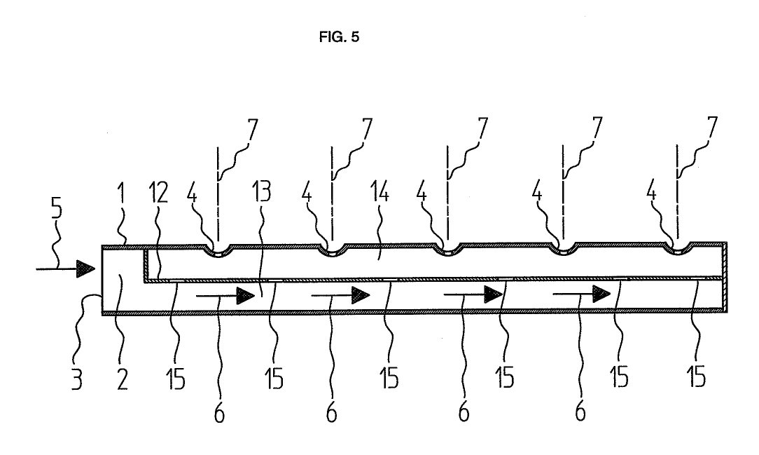

The illustration according to FIG. 5 shows a further, fourth design variant of the solution proposed according to the invention for an optimized nozzle system.

As can be seen in the illustration according to FIG. 5, a flow region which is decoupled from the longitudinal flow 6 in the spray pipe cross section 2 of the spray pipe 1 is generated in the case of this solution. To this end, the spray pipe 1 is subdivided in the longitudinal direction by at least one partition wall 12 which extends parallel to the casing of the spray pipe 1. As a result, at least two channels are produced in the spray pipe cross section 2 of the spray pipe 1. An outflow channel 14 is closed at its end face, so that it is not connected to the inflow opening 3 at the start of the spray pipe 1. The nozzle openings 4 are made in this separated-off region and are accordingly not directly subjected to the action of the longitudinal flow 6. The partition wall 12 is interrupted at several points by openings 15 which can be designed, for example, as circular holes or the like. The cleaning liquid emerges from a supply channel 13 through these openings, and through the openings 15 in the partition wall 12 into the outflow channel 14. As a result of this measure, identical and consistent nozzle jets 7 are likewise formed at all the nozzles, even if all the nozzle openings 4 are of identical design.

The partition wall 12 included in the spray pipe cross section 2 in the illustration according to FIG. 5 can be formed, for example, by a simple metal plate with holes being inserted. The advantages of this solution are its simplicity, which is advantageous in terms of production, its robustness and its good effect as regards displacement of longitudinal flow components away from the nozzle openings 4 formed in the casing of the spray pipe 1.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A spray pipe for subjecting items to be cleaned to the action of cleaning liquid in dishwashers, the spray pipe comprising:
a longitudinal extent; and
at least two nozzles for spraying the cleaning liquid onto items to be cleaned in the longitudinal extent,
wherein the flow of the cleaning liquid is deflected within the spray pipe in front of at least one nozzle in such a way that a jet emerging through a nozzle opening in the nozzle contains substantially no flow components which are directed in the longitudinal direction of the spray pipe and emerges from the at least one nozzle substantially orthogonally to the spray pipe.

2. The spray pipe as claimed in claim 1, further comprising at least one deflection body, which projects into the spray pipe by a height, for deflecting the flow.

3. The spray pipe as claimed in claim 2, wherein the at least one deflection body is arranged at a distance from the at least one nozzle, the distance not exceeding four times the height.

4. The spray pipe as claimed in claim 3, wherein the deflection takes place immediately in front of the at least one nozzle.

5. The spray pipe as claimed in claim 1, wherein measures for deflecting the flow are taken at all the nozzles or nozzle openings, and wherein jets emerge from nozzles of the same nozzle design substantially identically and uniformly.

6. The spray pipe as claimed in claim 1, wherein a calmed flow region without longitudinal directional components is generated by a deflection body being introduced into the flow cross section directly in front of at least one of the nozzles, as seen in the inflow direction.

7. The spray pipe as claimed in claim 6, wherein the deflection body is formed by stamping the spray pipe from the outside.

8. The spray pipe as claimed in claim 6, wherein the deflection body is inserted into the spray pipe as an additional component.

9. The spray pipe as claimed in claim 6, wherein the deflection body extends from an additional component radially inward in relation to an axis of symmetry of the spray pipe in the manner of a tongue.

10. The spray pipe as claimed in claim 1, wherein a calmed flow region without axial components is generated by the spray pipe being divided longitudinally into at least one supply channel and at least one outflow channel by at least one inserted partition wall, with the at least two or more nozzles branching off from the outflow channel and in the process the supply channel being connected to the outflow channel by one or more openings in the partition wall.

11. A machine for cleaning items to be cleaned, in particular a dishwasher, comprising at least one spray pipe as claimed in claim 1 for subjecting items to be cleaned to the action of cleaning fluid.

12. The spray pipe as claimed in claim 3, wherein the distance is twice the height.
